(19) United States
(12) Patent Application Publication
(10) Pub. No.: US 2008/0298887 A1
(43) Pub. Date: Dec. 4, 2008

(54) Panel and Clamping Fasteners

(75) Inventors: Dickory Rudduck, Chicago, IL (US); Grenfell Saxon Rudduck, Norwood (AU); Lachlan Richard Goldspink, New South Wales (AU)

Correspondence Address: TELEZYGOLOGY, INC., 520 W. ERIE STREET, SUITE 210, CHICAGO, IL, 60654, US

(73) Assignee: TELEZYGOLOGY, INC., Chicago, IL (US)

(21) Appl. No.: 11/813,386

(22) PCT Filed: Jan. 4, 2006
(86) PCT No.: PCT/AU06/00002

§ 371 Date: Aug. 1, 2008

(30) Foreign Application Priority Data
Jan. 5, 2005 (AU) 2005900041

(51) Int. Cl. F16B 21/02

(52) U.S. Cl. 403/384

(57) ABSTRACT

The invention provides a release for locking system particularly suitable for fastening a first element such as a panel (12) to a beam (35) adjacent to a second element, such as a another panel (42). The system is particularly useful for fastening panels on aircraft. The system includes a projection (32) for the first element (12), the projection having a locking cavity (44). Beam (35) includes an aperture (62) for receiving the projection (32). A locking means is adapted to engage the locking cavity (44) of the projection (32) when the projection (32) is received in the aperture (62), in order to lock the first element (12) to the beam (35), so as to be adjacent to the second element (42). The locking means includes material adapted to contract when activated, such as shape memory alloy wire (51, 52). The locking means includes engagement means (46) adapted to disengage the locking cavity (44) when the material (51 or 52) contracts. The invention also provides a second type of releasable fastening system. This has a shuttle (110) moveable between a locked position and an unlocked position. The system includes locking means (112, 108) for locking the shuttle (110) in the locked position and the unlocked position. This system also includes means such as shape memory alloy wire (121) for drawing the shuttle (110) to the unlocked position. The shuttle (110) is biased towards the locked position.

### TECHNICAL FIELD

This invention relates to fasteners and in particular to panel and clamping fasteners.

### BACKGROUND OF THE INVENTION

For convenience, the invention in its various aspects is described below in relation to fastening or clamping of panels or other elements to aircraft; however, it is to be understood that the invention is not limited to this application.

The invention in a first aspect is concerned with improvements in the current method of fastening panels or other elements to aircraft. Conventionally, aircraft panels are held in place by counter-sunk screws which may then have their heads sealed to minimise radar detection. When a panel or other element of the aircraft needs to be removed for some reason, for example for access, the screws and the sealant must be removed and then replaced when the panel or other element is replaced. Clearly, it is very time consuming to replace and reseal elements in this way.

Further, the nature of the screws currently used can provide for an unsatisfactory seal of the aircraft against ingress of foreign material. Even more importantly, the current arrangement may be unsatisfactory with respect to radar detection.

At present, a large number of screws is required in order to secure panels or other elements of the aircraft, because the screws are small and can secure only small sections of a panel at a time. Further, the nature of the screws is such that the seal produced between one panel and another may be unsatisfactory.

It is an object of the present invention, at least in some embodiments, to reduce the time and effort required to fasten panels or other elements of aircraft in place.

It is another object of the invention, at least in some embodiments, to improve the seal that may be achieved between panels or other elements, one to another or between those elements and frames or other underlying structures.

It is a further object of this invention, in a particularly preferred embodiment, to provide improvements in the manner of fastening and sealing elements such as hatches and doors to aircraft.

### DISCLOSURE OF THE INVENTION

In aspects of the invention discussed below, reference is made to material adapted to contract when activated.

The material adapted to contract when activated is preferably shape memory alloy wire. Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various aspects of the present invention, the shape memory alloy contracts when heated in situ. Shape memory alloy wire currently available, such as that called Nitinol, is capable of contracting by about 3% when activated by heating.

Activation of the material adapted to contract when activated is preferably achieved through electrical resistance heating, with a wire feed to the assembly. Activation of the shape memory alloy wire can be initiated from a central location, using the wiring system of, for example, the aircraft. Power may be supplied by batteries or by induction or any other suitable means. It is within the scope of this invention that the activation is initiated by remote means, such as a hand held tool operating through the use of any suitable form of energy, including microwave, magnetic, electro-magnetic, sonic, infra-red, radio frequency and so on.

The scope of the invention in its various aspects is not necessarily limited to the use of shape memory alloy. Other material may also be useful. Also, while activation may take place through heating, other means of activation may be suitable and are within the scope of this invention.

Accordingly, in a first aspect, the invention provides a releasable locking system for locking a first element to a beam adjacent to a second element, the system including:
a projection for the first element, the projection having a locking cavity;
an aperture in the beam for receiving the projection;
a locking means adapted to engage the locking cavity of the projection when the projection is received in the aperture to lock the first element to the beam so as to be adjacent to the second element; and
a locking means including material adapted to contract when activated;
   wherein the locking means comprises or includes engagement means adapted to disengage the locking cavity when the material contracts.

The projection may be chosen from a large range of suitable shapes. As one example, the projection may be a pin which is generally circular in cross-section, tapering in towards its leading end. The pin may be a stud, peg, bolt or any other suitable element.

As another example, the projection may be a continuous strip, or may be a combination of strip and pin. These are illustrated in the drawings. Other configurations are possible.

The projection may be formed integrally with or attached to an element to be fastened, such as a panel. The attachment may be by adhesion, clipping or other suitable means.

The locking cavity may take any suitable form but preferably is one or more indentations or a groove. If a groove, the groove may be adapted to receive the engagement means in some or all of the groove.

The aperture is preferably formed centrally in a body which may house the engagement means and the locking means. The aperture is preferably of the same shape as the cross-sectional shape of the projection, for example, circular or a slit. The aperture may take any other suitable shape or combination of shapes.

If the projection is designed with a taper, it may be pushed into the aperture and be engaged without the need for any activation of the material. The taper on the projection may serve to form a ramp pushing the engagement means apart until it snaps into the locking cavity, such as a groove. The locking means can then ensure that the engagement means maintains this configuration while the fastening system is engaged.

The engagement means may be a clip, but preferably is one or a plurality of elements, such as teeth. The invention is not limited to these embodiments.

When the engagement means includes or consists of one or a plurality of elements such as teeth, each of these is preferably designed to fit into the locking cavity, in this embodiment being a groove in the projection. Preferably, there is a plurality of such elements, being teeth.

In this embodiment, the teeth are preferably surrounded by a movable body, such as a shuttle. In one embodiment, the shuttle is rotatable to an engagement position, where the teeth engage the groove, and to a disengagement position, where the teeth disengage from the groove. To disengage the fastening system, it is necessary to activate the material so that it contracts and pulls the shuttle out of engagement with the teeth, which can release the groove.

In a particularly preferred embodiment, the shuttle has one or more apertures or spaces into which the engagement means may be received in the unlocking position. When the engagement means, such as teeth, are not in these apertures or spaces, the shuttle is designed to push the engagement means into the locking cavity and hence to the locking position.

In another embodiment, the shuttle may be movable in a linear path and may include or be associated with means adapted to engage the engagement means and draw them out of engagement with the locking cavity, when the shuttle is moved to the unlocking position.

The shuttle may be moved by the locking means which includes material adapted to contract when activated. Preferably, this material is shape memory alloy wire, as discussed above. In one embodiment, the shape memory alloy wire is wound around the shuttle which is rotatable within a body for the fastening system. In this embodiment, the shape memory alloy wire is attached at one end to the shuttle and at the other to a non-rotatable part of the fastener. When the shape memory alloy wire is caused to contract by the application of suitable energy to reach the necessary temperature, the shuttle can rotate from the locking position to the unlocking position. A second shape memory alloy wire may be similarly connected to the shuttle in order to rotate it from the unlocking position to the locking position.

In another embodiment, the shape memory alloy wire is adapted to draw the shuttle out of engagement with the engagement means, allowing the engagement means to release the locking cavity.

It is particularly preferred that a retractable cap is included as part of an ejector in the releaseable fastening system of the invention, to present a smooth appearance when the projection is not inserted in the cavity. An example of this is described in connection with the drawings, below. If the ejector is included, it can be pushed further into the cavity by the projection when the projection is inserted in the cavity, the ejector being spring biased towards the cavity opening. This embodiment can have a clean flat visual finish when not in use.

It will also be appreciated that the invention may provide for “insertion anytime” in that the projection may be merely pushed into the aperture for engagement to occur. Alternately, the fastening system of the invention may require positive disengagement of the engagement means before the projection may be inserted in the cavity.

Preferably, the fastening system of the invention includes means for indicating the locked or unlocked states of the fastening system. By way of a non-limiting example, this can be effected by microswitches in contact with the shuttle or an extension thereof. Information as to the locked or unlocked status of the fastening system can be conveyed to an indicator light or similar indicium locating in a convenient position.

The engagement means is preferably biased towards the locking position, preferably by a coiled spring, positioned in the fastening system of the invention so that the spring urges the locking means, such as the shuttle, toward the locking position. When the material is activated, this may cause compression of the spring, which accordingly can return the locking means towards the locking position once the material is no longer activated.

The fastening system of the invention may include many other options. One such option is the sensing of change in temperature, for example to indicate a dangerously high temperature, so that an appropriate alarm can be initiated, the fastening system of the invention being wired into, for example, the aircraft electrical system. Other sensing functions may be incorporated in the fastening system of the invention.

The fastening system of the invention may include multiple material such as shape memory alloy wire. This can provide redundancy, so that if activation of one shape memory alloy fails to operate the system, the other or another of the wires can be activated.

The fastening system of the invention may also include a temperature sensor for sensing the temperature of the shape memory alloy wire in the preferred embodiments. This can adjust the amount of energy applied to the shape memory alloy wire, depending on sensed temperature, to take into account varying conditions. For example, if the temperature is relatively low, a larger amount of power may need to be delivered to the shape memory alloy wire to heat it to the desired temperature. Conversely, if the temperature is high, the amount of power to be delivered to the shape memory alloy wire in order to cause it to contract may be far less. A temperature sensor can enable feedback and cause adjustment of power delivery in this regard.

In an especially preferred embodiment, the fastening system includes a microprocessor which can carry out one or several roles. The microprocessor can control the energy delivery to the shape memory alloy wire, preferably by a temperature-dependent algorithm. The microprocessor can control temperature of the shape memory alloy wire. It can sense the state of the fastening system and whether it is engaged or not. The microprocessor can detect whether the projection is present in the fastening system. The microprocessor may report this, along with secondary sensed information, to a network of which the fastening system forms a part. Preferably, the microprocessor carries out all these roles.

In the second aspect, this invention provides a releaseable fastening system which includes:

a shuttle movable between a locked position and an unlocked position;
a locking means for locking the shuttle in the locked position and the unlocked position; and
means for drawing the shuttle to the unlocked position, the shuttle being biased towards the locked position.

The shuttle is preferably integrated with or connected to a push rod or piston. Preferably, the push rod or piston moves in a generally linear path. However, it is intended that the push rod or piston may be flexible or able to move in a path which is not strictly linear, and which may even be arcuate. The purpose of this is to enable sequential unlocking of a series of such fastening systems, in a smooth manner. This may be especially preferred for aircraft doors and hatches, for example.

The locking means is preferably generally transverse to the push rod or piston and able to move in a path which is generally at right angles to the path of the piston. It is preferred that the locking means has an aperture, such as a keyhole aperture, which has a wide part and a narrow part. In this embodiment, the piston has grooves or indentations. When the locking means moves in one direction relative to the piston, the narrow part of the aperture engages the grooves and prevents the piston from travelling, thus locking the piston in place. When the locking means moves in the opposite direction relative to the piston, the piston is freed from engagement with the aperture and may travel along its path.

Preferably, there is at least one intermediate position between the locked position and the unlocked position, in which the piston may be locked.

The drawing means may include any suitable means, including but not limited to material which contracts when activated, to draw the piston away from the locking position.

Optionally, the fastening system of the second aspect of the invention may include a seal. This can be used to seal a hatch or door against an adjacent panel on an aircraft, for example. The seal may be attached to or part of the shuttle. Preferably, the seal is designed to abut a complementary surface on the adjacent panel. Sealing in this manner may assist in keeping a low profile to avoid radar detection.

### BRIEF DESCRIPTION OF THE DRAWINGS

The invention will now be described in connection with certain non-limiting examples thereof in the accompanying drawings (not all to the same scale), in which:

FIG. 1 (prior art) shows a side view of a conventional aircraft;

FIG. 2 (prior art) shows an elevation of part of a panel of the conventional aircraft of FIG. 1, indicating the position of sealed counter-sunk screw heads;

FIG. 3 (prior art) shows a sectional view through both the panel shown in FIG. 2 and an adjoining panel;

FIG. 4a shows a side view of part of an aircraft having a panel incorporating a first preferred embodiment of the releaseable locking system of the first aspect of the invention;

FIG. 4b shows, in simplified sectional view, part of the panel of the aircraft of FIG. 4a, illustrating how the panel fastens to the beam;

FIG. 5a shows a side view of part of an aircraft having a panel incorporating a second embodiment of the releaseable locking system of the first aspect of the invention;

FIG. 5b shows, in simplified sectional view, part of the panel of the aircraft of FIG. 5a, illustrating how the panel fastens to the beam;

FIG. 6a shows in side view part of an aircraft having a panel incorporating an embodiment of the releaseable locking system of the second aspect of the invention;

FIG. 6b shows, in simplified sectional view, part of the panel of the aircraft of FIG. 6a, illustrating how the panel fastens to the underlying structure;

FIG. 7 shows a detailed sectional view of the locking system of FIG. 4a in the locked position;

FIG. 8 shows in perspective view part of the locking system of FIG. 7;

FIG. 9 is a perspective view of the locking system of FIG. 7;

FIG. 10a shows a detailed sectional view of the locking system of FIG. 7 during the opening process;

FIG. 10b shows in perspective view part of the beam in FIGS. 7 and 10a;

FIG. 11 shows a detailed sectional view of the second embodiment of the first aspect of the invention as in FIGS. 5a and 5b, illustrating the locked position;

FIG. 12a shows in perspective view part of the beam in FIG. 11;

FIG. 12b shows a different form of beam;

FIG. 13 shows a further embodiment of the locking system, combining features of the first and second embodiments of the first aspect of the invention;

FIG. 14 shows a detailed sectional view of the embodiment of FIG. 11, illustrating the open position;

FIG. 15 is a side sectional view of part of a door or hatch incorporating a preferred embodiment of the second aspect of the invention, showing the door or hatch prior to locking and sealing;

FIG. 16 shows a sectional view of the system of FIG. 15 in an intermediate position;

FIG. 17 shows a sectional view of the system of FIG. 15 in the closed position;

FIG. 18 shows in perspective view part of the system of FIGS. 15 to 17;

FIG. 19 is a perspective view of a detail of the system of FIGS. 15 to 17;

FIG. 20 is a plan view of the embodiment in FIGS. 15 to 17 in the open position; and

FIG. 21 is a plan view of the embodiment in FIGS. 15 to 17 in the closed position.

### BEST METHODS FOR CARRYING OUT THE INVENTION

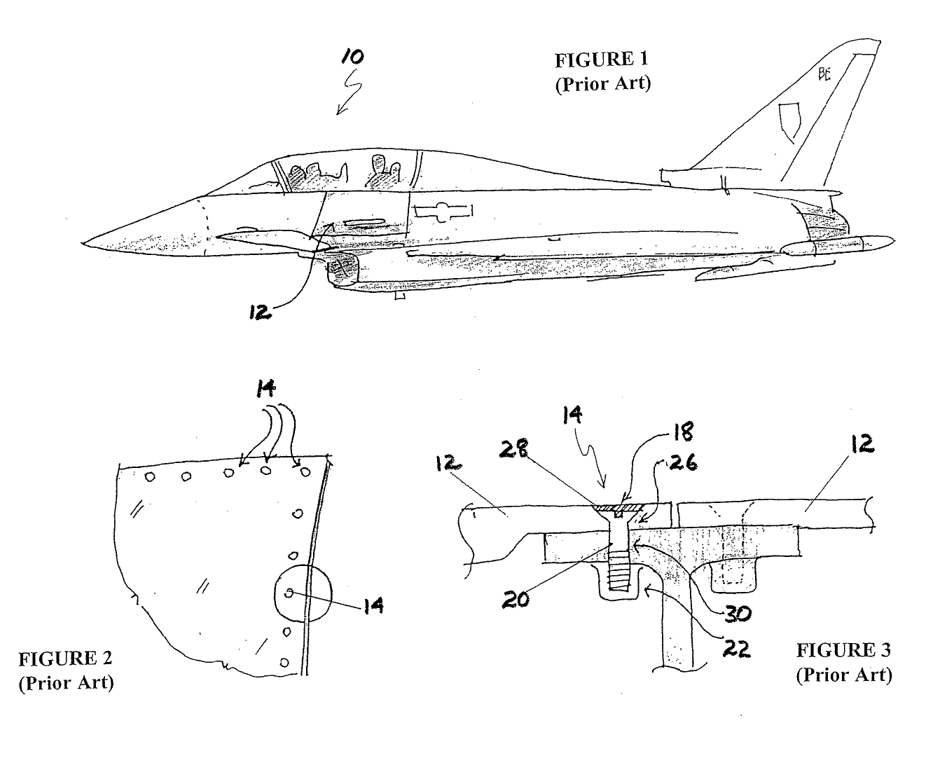

Referring first to FIGS. 1 to 3, “Stealth” aircraft 10 has access panel 12 held onto an underlying structure (beam 16 in FIG. 3) by screws 14 (FIG. 2). A detail of the circled screw 14 in FIG. 2 is shown in FIG. 3. Each screw 14 has a head 18 and a shank 20, which is inserted in captive nut 22. Screws 14 are countersunk in depressions 26 in panel 12 and heads 18 are covered by sealant 28 to reduce detection by radar.

A series of holes 30 to receive shanks 20 are formed in beam 16.

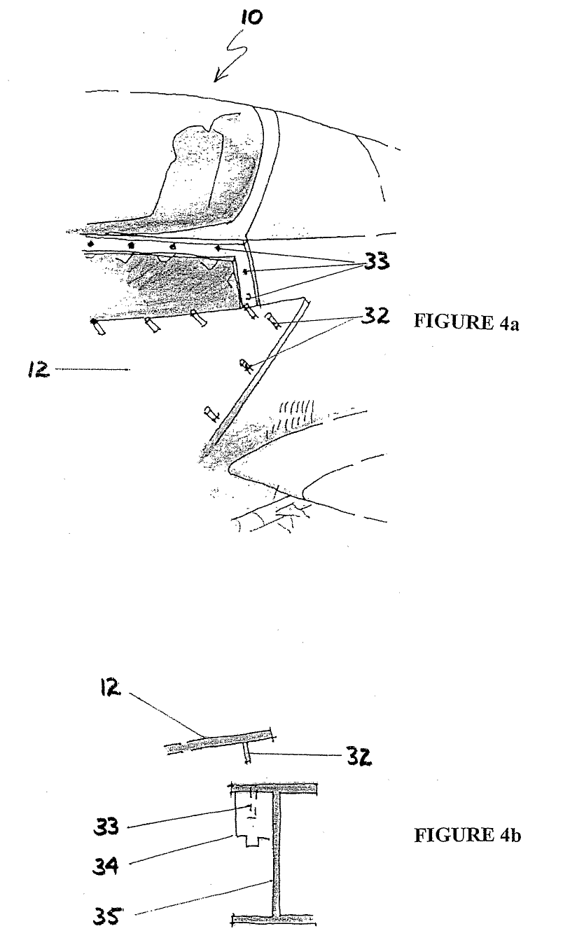

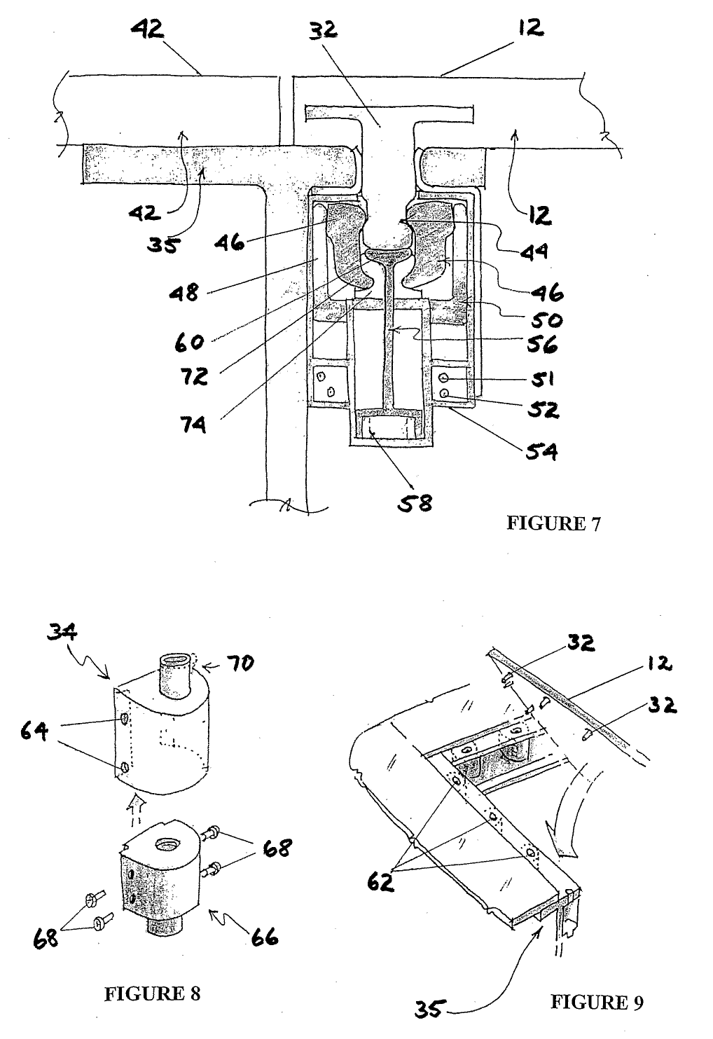

FIGS. 4a and 4b show an embodiment of the releasable fastening system of the invention where the projection is a pin 32, made integrally with or fixed to panel 12. Pin 32 is received in aperture 33 in body 34 attached to beam 35 as described in more detail in relation to FIGS. 7 to 10.

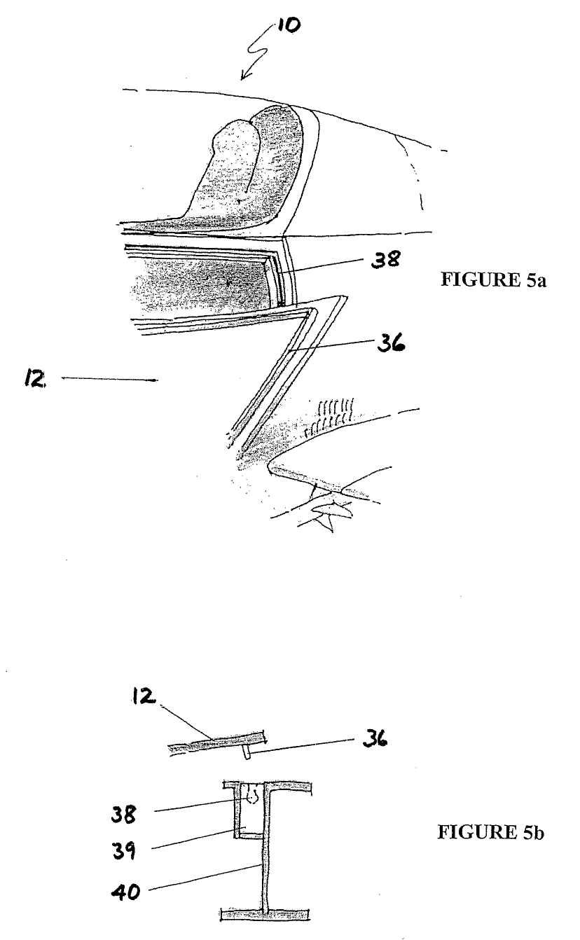

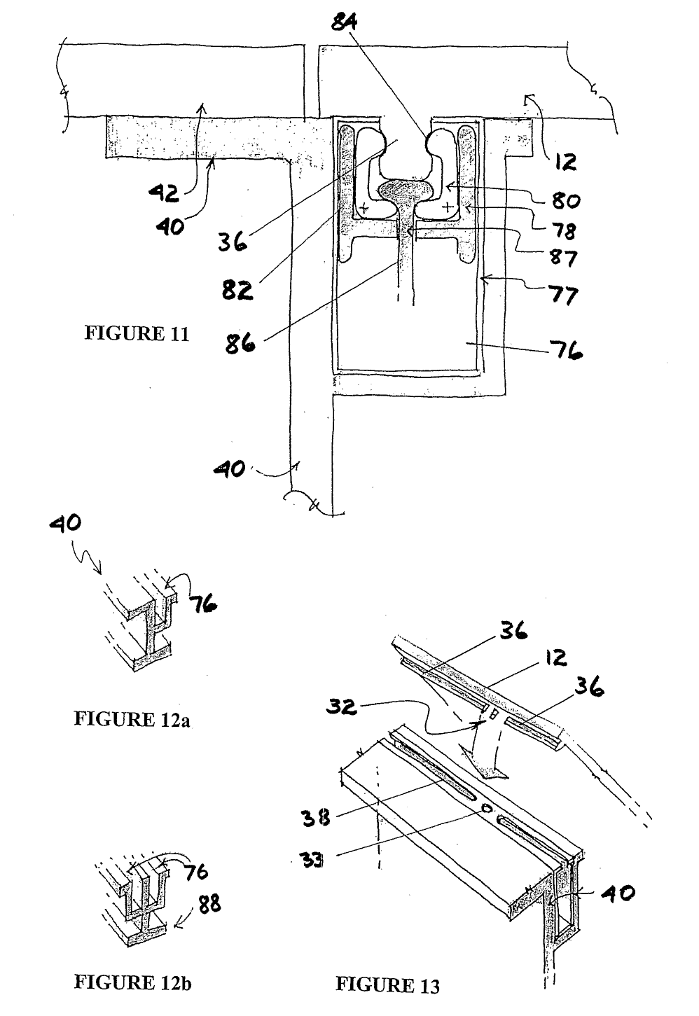

FIGS. 5a and 5b illustrate a different embodiment of the releasable fastening system, where the projection is in the form of a strip 36. Details are shown in FIG. 11. Strip 36 is received in slit 38 in a cavity 39 in beam 40.

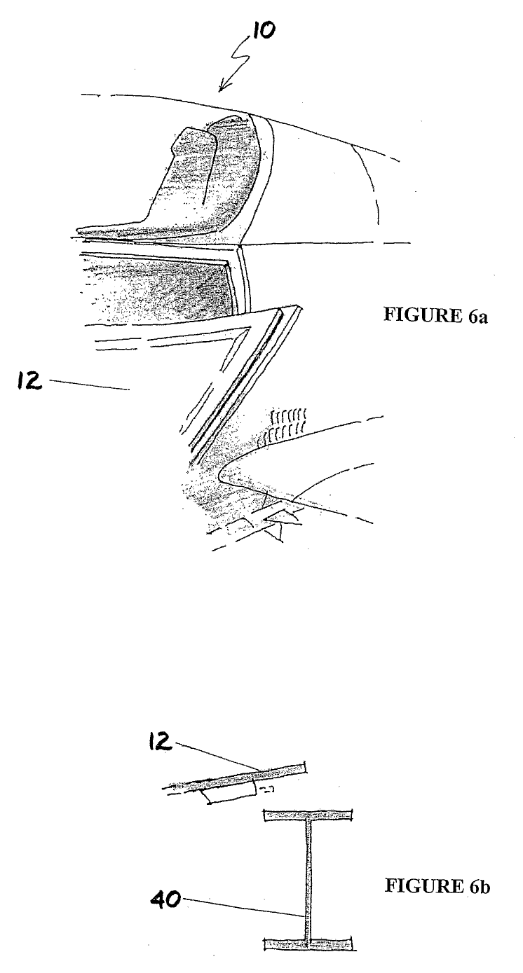

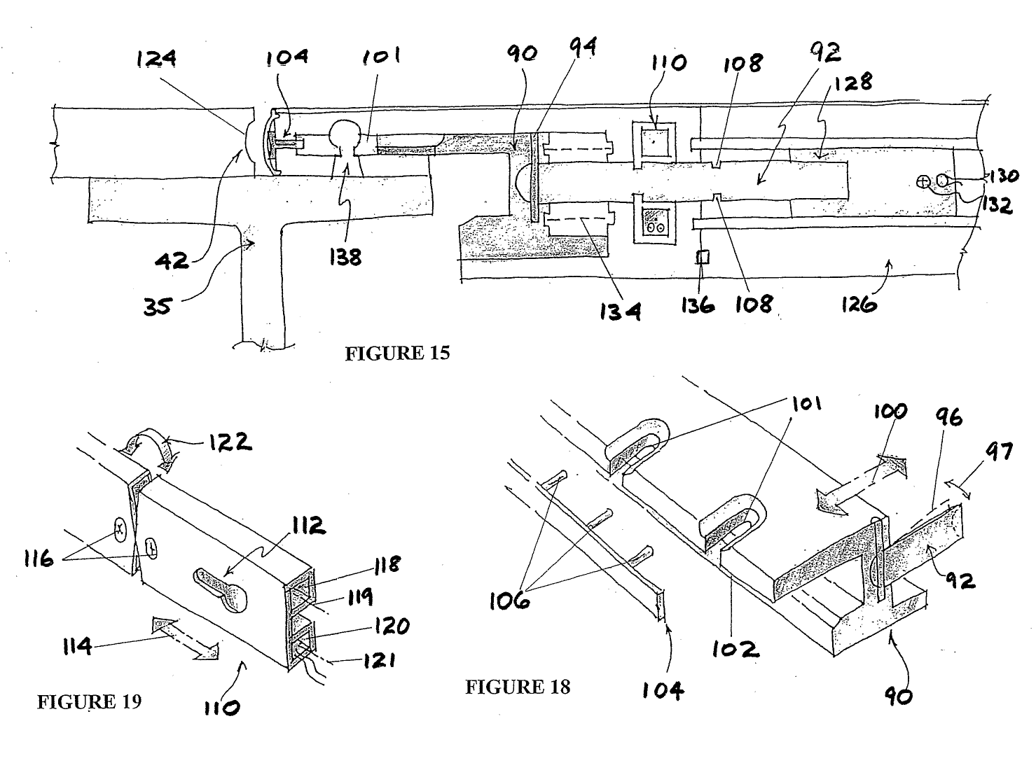

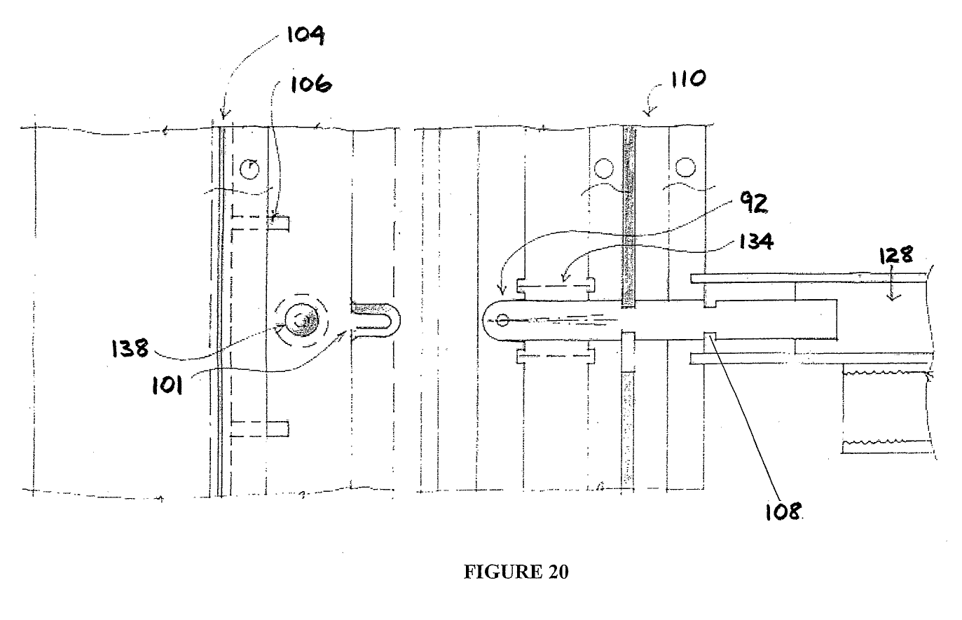

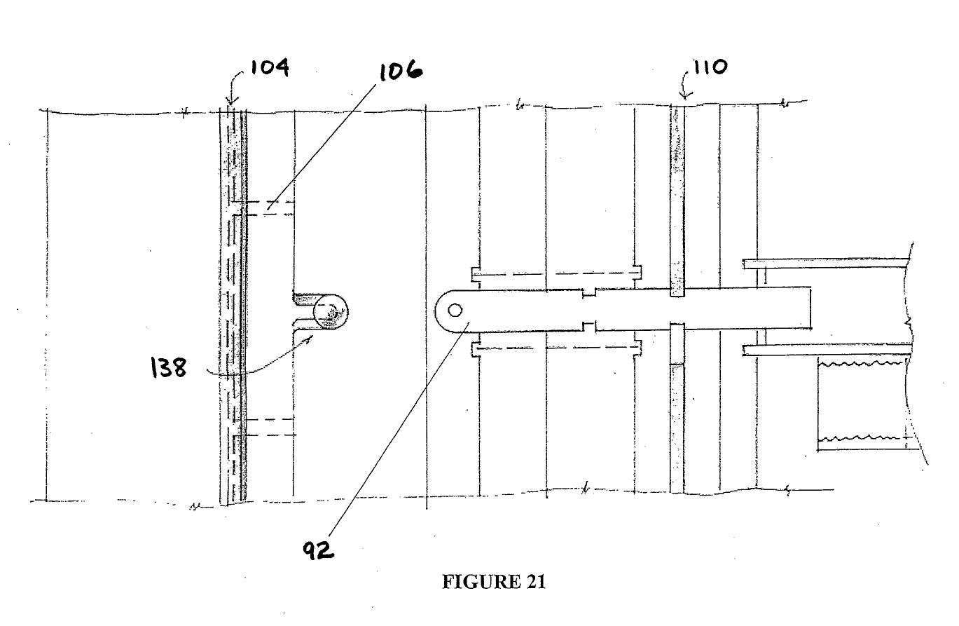

FIGS. 6a and 6b illustrate an embodiment of the clamp style fastening system of the second aspect of the invention, with a beam 35. Details are shown in FIGS. 15 to 21.

As shown in FIGS. 7 to 10b, access panel 12 is fastened adjacent fixed panel 42 via beam 35. Pin 32 is set into panel 12 and includes a peripheral groove 44. Teeth 46 engage groove 44 and, in the locked position shown in FIG. 7, are held in the engaged position by arms 48 of rotatable shuttle 50.

Shuttle 50 includes shape memory wire 51 and 52 wound around base 54 of shuttle 50. Wire 51 is wound clockwise and wire 52 is wound anticlockwise. Activation of wire 51 by heating through a power source (not shown) will rotate shuttle 50 in one direction, while activation of wire 52 will rotate shuttle 50 in the opposite direction. Shuttle 50 may be biased by a spring (not shown) towards the locked position in FIG. 7.

Ejector 56 is biased by spring 58 to eject pin 32 once released by teeth 46. Ejector 56 includes cap 60 or enlarged head which presents a streamlined appearance when pin 32 is not inserted in aperture 62 (FIG. 9).

FIG. 8 shows how outer body 34 may be attached to beam 35 through screws 64. Fastener body 66 is inserted in body 34 and fastened therein by screws 68. One fastener body 66 may be substituted for another by insertion in outer body 34.

Outer body 34 has swaged neck 70 to finish off integration of the fastening system in beam 35.

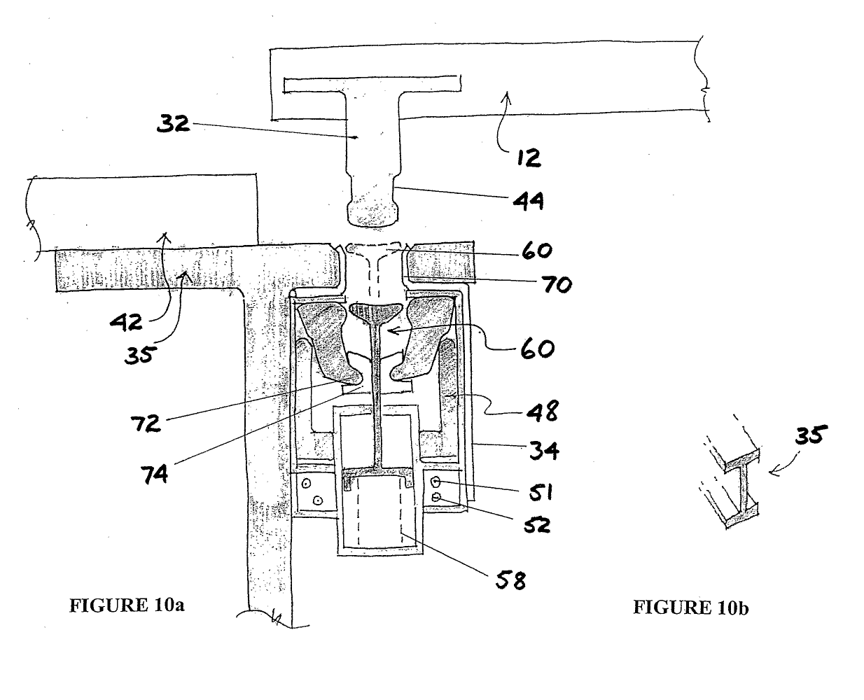

When pin 32 is inserted through neck 70 and into aperture 62, pin 32 depresses ejector 56 against the bias of spring 58. Teeth 46 engage groove 44 and are held in position by arms 48. Arms 48 may be biased to this position by a spring (not shown) and/or wire 51 may be activated to achieve locking. To unlock panel 12, wire 52 is activated to rotate shuttle 50 so that arms 48 no longer bear against teeth 46, which accordingly open as shown in FIG. 10. Feet 72 of teeth 46 engage stop 74 (FIGS. 7 and 10). Spring 58 causes ejector 56 to eject pin 32.

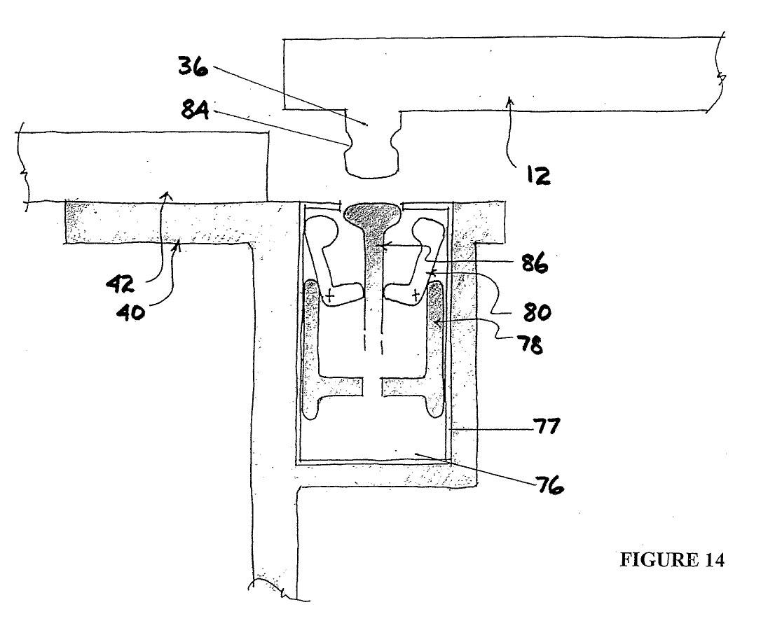

Referring now to FIGS. 11, 13 and 14, in this embodiment access panel 12 has integral strip or flange 36, which may be continuous as shown in FIG. 5a, or which may be combined with pins 32 as shown in FIG. 13. Use of pins 32 may provide shear resistance.

Beam 40 is constructed with channel 76 for housing body 77 of the fastening system, which is similar to that in FIGS. 7 and 10a, except that shuttle 78 may move linearly instead of rotating. Teeth 80 are shown in FIG. 11 in the locked position, with arms 82 of shuttle 78 locking teeth 80 in position. Activation of shape memory alloy wire (not shown) or other suitable material can draw shuttle 78 downwardly so that arms 82 no longer lock teeth 80 into engagement with groove 84. Ejector 86, which is inserted through a seal 87 in shuttle 78, ejects strip 36 or pin 32 under the influence of a spring (not shown, but like that in FIG. 7).

Beam 40 is also shown in FIG. 12a. Shown in FIG. 12b is modified beam 88, which has two channels 76, for fastening two adjacent removable panels 12, rather than one removable panel 12 adjacent a fixed panel 42 as in FIG. 11.

The embodiment of the second aspect of the invention shown in FIGS. 15 to 21 shows a clamp style fastener as outlined in FIG. 6b. FIG. 15 shows clamp shuttle 90 with push rod 92 attached by pin 94. As shown by dotted line 96 and arrow 97 in FIG. 18, push rod 92 is sufficiently flexible to be movable out of strict alignment, for smooth opening as explained further below. Clamp shuttle 90 is designed to move backwards and forwards as indicated by arrow 100.

Clamp shuttle 90 includes shear pin slots 101 and horizontal slot 102 to accept seal 104. Seal 104 includes pins 106 which enter slot 102.

As shown in FIG. 15, push rod 92 includes grooves 108. These are intended for engagement with lock shuttle 110, which is shown in more detail in FIG. 19. Lock shuttle 110 includes keyhole shaped slot 112. Lock shuttle 110 is caused to move back or fourth in the direction of arrow 114 to lock or unlock push rod 92, by shape memory actuator wires in cavities 118 and 120. Wire 119 in cavity 118 is activated to move lock shuttle 110 to the left in FIG. 19; wire 121 in cavity 120 is activated to move lock shuttle 110 to the right in FIG. 19.

When grooves 108 of push rod 92 engage the narrow part of keyhole slot 112, push rod 92 is locked in position. Push rod 92 is freed when lock shuttle 110 is moved so that push rod 92 is positioned in the wide part of keyhole slot 112.

Lock shuttle 110 can allow panel or door 126 to be in the unlocked position for extended periods.

Lock shuttle 110 can swivel about screws 116, as shown by arrow 122 (FIG. 19), so that it can allow for curved constructions.

FIG. 15 shows fixed panel 42, having seal rebate 124, fixed to beam 35. Removable panel or door 126 includes clamp shuttle 90, push rod 92 and lock shuttle 110. Also included is piston or activator 128. In this illustration, this is activated by shape memory alloy wires 130 and 132. However, piston 128 may be activated by other means, such as by a motor or hydraulic means for example. Spring 134 biases clamp shuttle 90 towards the closed position, even if no energy is supplied to the assembly. Embedded microprocessor 136 can provide control and feedback of operations as described above and can coordinate with the aircraft system or be operated by electromagnetic induction or any other suitable means.

Shear pin 138 is located in slot 101 to assist in alignment and limit movement of clamp shuttle 90.

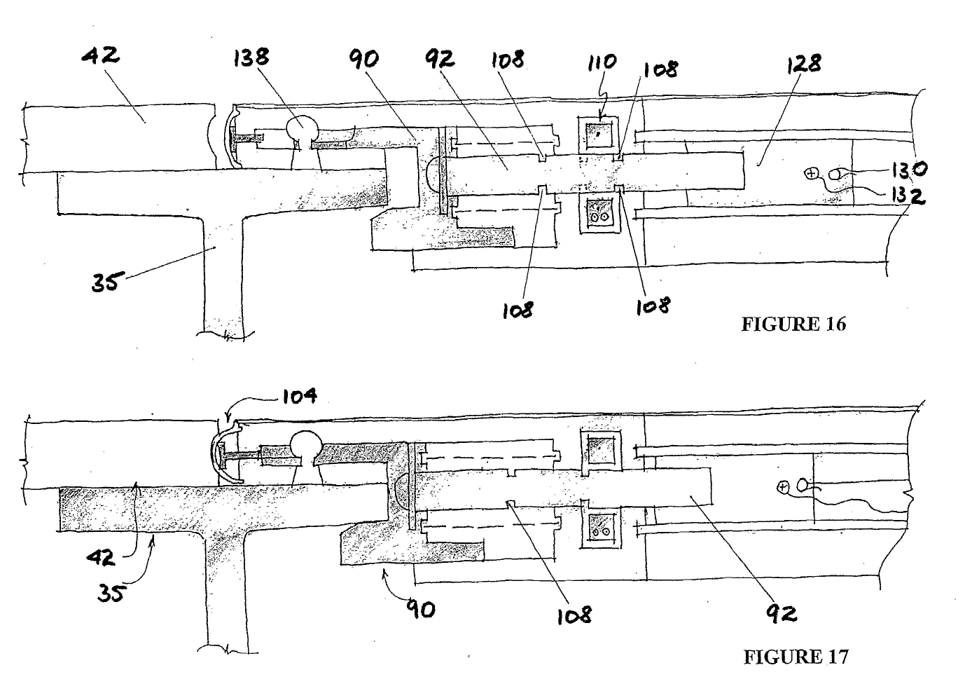

Since push rod 92 has two grooves 108, it can be locked in either position—open, as shown in FIG. 15, or closed, as shown in FIG. 17. In both these positions, one of grooves 108 engages the narrow part of keyhole slot 112. There is also an intermediate position illustrated in FIG. 16, where none of the grooves 108 is engaged. Sensors (not shown) may report the position of push rod 92 and/or lock shuttle 110.

It will be noted, comparing FIGS. 16 and 17, that seal 104 is caused to bulge when clamp shuttle 90 clamps on beam 35. The aircraft may be pressurised at this stage. This seal may enable a smooth outer skin to the aircraft.

Other forms of seal may be used, such as a “feather” seal.

To unlock the assembly, the embedded microprocessor may control the following steps: first, energy is supplied to clamp shuffle 90, to take load off spring 134. Next, locking shuttle 110 is caused to unlock, freeing push rod 92. Push rod 92 may be locked in the open position by engagement of grooves 108 in keyhole slot 112 (FIG. 19). If locking shuttle 110 is again unlocked from push rod 92, spring 134 urges push rod 92 to the locked position, and locking shuttle 110 may be activated to lock push rod 92 in the locked position.

It will be appreciated that no power is necessary to maintain the clamp assembly in the locked position. It will also be appreciated that the fastening system can be supplied in any length desired.

The clamp fastener may be particularly suitable for smooth opening or closing of doors on aircraft, because a series of the fastening systems may be programmed to open or close sequentially. This can avoid sudden shocks to the aircraft. It was mentioned above that the push rod may be flexible so that it can move out of strict alignment with its normal path. This may be necessary if some of the other fastening systems have already been actuated: the door will no longer be perfectly square in the opening.

While the description above has dealt with aircraft, the invention in its various aspects can have application in other areas. Mentioned by way of illustration are doors in buildings and in marine structures, such as submarines.

### INDUSTRIAL APPLICABILITY

It will be appreciated by one skilled in the art that the releasable fastening systems of the invention are readily applicable industrially. In particular, they have applicability in areas requiring streamlined external appearances, such as in relation to aircraft, especially of the “stealth” type.

It will also be readily appreciated that the fastening systems of the invention are capable of locking and release far more readily than the laborious screw system of the prior art.

1. A releasable locking system for locking a first element to a beam adjacent to a second element, the system including:
a projection for the first element, the projection having a locking cavity;
an aperture in the beam for receiving the projection;
a locking means adapted to engage the locking cavity of the projection when the projection is received in the aperture to lock the first element to the beam so as to be adjacent to the second element; and
a locking means including material adapted to contract when activated;
wherein the locking means comprises or includes engagement means adapted to disengage the locking cavity when the material contracts.

2. The fastening system of claim 1, wherein the first element is a door or panel.

3. The fastening system of claim 1 or 2, wherein the projection is a pin, stud, peg, bolt, a continuous strip or a combination of pin and continuous strip.

4. The fastening system of any one of claims 1 to 3, wherein the locking cavity is a groove around the perimeter of the projection.

5. The fastening system of any one of claims 1 to 4, wherein the engagement means is one or more teeth.

6. The fastening system of any one of claims 1 to 5, wherein the engagement means is adapted to engage or disengage the locking cavity of the projection by operation of a movable shuttle.

7. The fastening system of claim 6, wherein the shuttle is adapted to move by rotation.

8. The fastening system of claim 6, wherein the shuttle is adapted to move linearly.

9. The fastening system of claim 7, wherein the material adapted to contract when activated is wound around or through the shuttle.

10. The fastening system of claim 8, wherein the material adapted to contract when activated is adapted to draw the shuttle along a linear path.

11. The fastening system of any one of claims 1 to 10, wherein the material adapted to contract when activated is shape memory alloy wire.

12. The fastening system of any one of claims 1 to 11, which includes a microprocessor.

13. The fastening system of claim 12, wherein the microprocessor is adapted to control energy delivered to the material adapted to contract when activated.

14. The fastening system of claim 12 or 13, wherein the microprocessor is adapted to sense whether the engagement means is engaged or disengaged.

15. The fastening system of any one of claims 12 to 14, wherein the microprocessor is adapted to control temperature of the material adapted to contract when activated.

16. The fastening system of any one of claims 1 to 15, wherein the engagement means is biased towards engagement with the locking cavity.

17. A releasable fastening system which includes a shuttle movable between a locked position and an unlocked position;
a locking means for locking the shuttle in the locked position and the unlocked position; and
means for drawing the shuttle to the unlocked position, the shuttle being biased towards the locked position.

18. The fastening system of claim 17, wherein the shuttle is integrated with or connected to a push rod or piston.

19. The fastening system of claim 18, wherein the push rod or piston is adapted to move in a generally linear path.

20. The fastening system of claim 18 or 19, wherein the push rod or piston is sufficiently flexible to be movable in an arcuate path.

21. The fastening system of any one of claims 18 to 20, wherein the locking means is movable in a path which is generally at a right angle to the push rod or piston path.

22. The fastening system of any one of claims 17 to 21, wherein the locking means has an aperture with a wide part and a narrow part.

23. The fastening system of any one of claims 17 to 22, wherein the drawing means includes material adapted to contract when activated.

24. The fastening system of claim 23, wherein the material adapted to contract when activated comprises or includes shape memory alloy wire.

25. The fastening system of any one of claims 17 to 24, which includes a seal.

26. A releasable fastening system substantially as herein described with reference to FIGS. 4a, 4b and 7 to 10b or FIGS. 5a, 5b and 11, 12a, 13 and 14 or FIGS. 6a and 6b and 15 to 21 of the accompanying drawings.
